(19) United States
(12) Patent Application Publication
(10) Pub. No.: US 2024/0330479 A1
(43) Pub. Date: Oct. 3, 2024

(54) SMART PATCH RISK PREDICTION AND VALIDATION FOR LARGE SCALE DISTRIBUTED INFRASTRUCTURE

(71) Applicant: BMC Software, Inc,, Houston, TX (US)

(72) Inventors: Vikram Kamate, Pune (IN); Ajoy Kumar, Santa Clara, CA (US)

(21) Appl. No.: 18/194,612

(22) Filed: Mar. 31, 2023

(51) Int. Cl. G06F 21/57; G06F 8/65

(52) U.S. Cl. CPC G06F 21/577; G06F 8/65; G06F 2221/033

(57) ABSTRACT

Systems and techniques for implementing a change to a plurality of devices in a computing infrastructure include generating a risk prediction model, where the risk prediction model is trained using a combination of supervised learning and unsupervised learning and identifying, using the risk prediction model, a first set of devices from the plurality of devices having a low risk of failure due to implementing the change and a second set of devices from the plurality of devices having a high risk of failure due to implementing the change. A schedule is automatically generated for implementing the change to the first set of devices. The change is implemented on a portion of the first set of devices according to the schedule. The risk prediction model is updated using data obtained from implementing the change on the portion of the first set of devices.

### BACKGROUND

Error correction of software, also called, patching, is typically performed on most software including operating systems, business applications, applications, and third-party applications. Information technology (IT) organizations are under tremendous pressure to patch large-scale infrastructure at speed without causing disruptions to the use of the infrastructure. When patches or any type of changes are planned for infrastructure, there may be a very low predictability on which patches or changes will be successful and which will not.

Specifically, IT organizations face challenges that include patch risk and change risk predictability, which is the ability to predict risk in patching and in changes made to the software. Further challenges include challenges to build a machine learning (ML) model because the number of failed patches is very low causing low accuracy of ML models. Even further challenges include building an optimal patching schedule across tens to thousands of servers (containers and applications) that are geographically distributed because of the human tribal knowledge typically needed to build such an optimal schedule.

### SUMMARY

According to some general aspects, a computer program product may be tangibly embodied on a non-transitory computer-readable storage medium and may include instructions. When executed by at least one computing device, the instructions may cause the at least one computing device to generate a risk prediction model, where the risk prediction model is trained using a combination of supervised learning and unsupervised learning, and identify, using the risk prediction model, a first set of devices from the plurality of devices having a low risk of failure due to implementing a change and a second set of devices from the plurality of devices having a high risk of failure due to implementing the change. A schedule is automatically generated for implementing the change to the first set of devices. The change is implemented on a portion of the first set of devices according to the schedule. The risk prediction model is updated using data obtained from implementing the change on the portion of the first set of devices. The identifying, the generating, the implementing, and the updating are iteratively performed.

According to other general aspects, a computer-implemented method may perform the instructions of the computer program product. According to other general aspects, a system may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example flow process for generating a risk prediction model.

FIG. 2 illustrates an example table of seed patch data.

FIG. 3 illustrates an example graphic for monitoring anomalies and critical incidents after implementing a change to a device.

FIG. 4 illustrates an example table that illustrates a comparison of metric values before and after a patch is applied.

FIG. 5 illustrates an example table of patterns of correlation between configuration variables and monitoring metrics.

FIG. 6, illustrates an example table of the correlation transformed into numerical values.

FIG. 7 illustrates an example decision tree.

FIG. 8 illustrates an example table of event data.

FIG. 9 illustrates an example table of scores for events.

FIG. 10 illustrates an example table related to a generative ML model.

FIG. 11 illustrates an example of clustering.

FIG. 12 illustrates an example table with enriched training data.

FIG. 13 illustrates example tables of aggregated failure rate across services with insights.

FIG. 14 illustrates an example process for iteratively training the risk prediction model.

FIG. 15 illustrates an example process for a continuous patching plan.

FIG. 16 illustrates an example process for another continuous patching plan.

FIG. 17 illustrates an example block diagram of a system for implementing changes on devices.

### DETAILED DESCRIPTION

Described systems and techniques determine a risk of implementing changes to devices including changes such as software patches to software on devices in a computing infrastructure. A risk prediction model is generated using a combination of historic data, test change data on a subset of devices, comprehensive data based on monitoring the implemented changes, and risk indicator features. The risk prediction model is used to predict which devices may be at risk for failing to implement the changes. In this manner, the prediction of high and low risk devices (e.g., high and low risk servers in a computing infrastructure) is automated using the risk prediction model.

As used herein, the term “changes” is used to indicate any type of change that is being made to a device in a computing infrastructure. Changes include, without limitation, error corrections, bug fixes, and modifications and updates made to the devices. One type of change described throughout this document is a software patch or simply a patch. A patch includes any change to a program on a computing device, where the program includes an application, firmware, executable code, instructions, or other code, etc. Many examples in this document refer to a patch or patches, but it is understood that this term is not limiting and is being used merely as an example. In many cases, the terms “change” and “patch” are used interchangeably throughout this document.

As used herein, computing infrastructure refers to a collection of hardware and/or software elements that provide a foundation or a framework that supports a system or organization. Computing infrastructure may include physical hardware components and virtual components. Computing infrastructure also may include hardware and software components for a mainframe computing system.

In general, training a risk prediction model uses labelled data with at least a minimum of 20% of failed change data (or failed patch data). One challenge faced is that a good inventory of failed changes typically does not exist for an organization implementing changes in a computing infrastructure. Highly imbalanced training data that includes only a small percentage of failed change data may result in very poor classification accuracy of the risk prediction model. One technical problem is to improve the performance and classification accuracy of the risk prediction model.

A technical solution to the technical problem uses data augmentation and/or feature enrichment to improve the performance and classification accuracy of the risk prediction model. The data augmentation includes comparing monitoring data before and after the change is applied on a device (e.g., server) and correlating the monitoring data with configuration data. Statistically significant differences in behavior in terms of key performance indicators (KPIs), resource utilization, response time, and availability are determined, and those devices are marked as latent failures. Data augmentation also includes identifying if any critical incidents were created after the change is implemented within, for example, X=3 (configurable) days and using text generated as part of or associated with the critical incidents to boost a degree of matching. If so, those servers are also marked as latent failures.

The feature enrichment includes adding risk predictor features to the dataset such as “failure rates”. The data augmentation and the feature enrichment are used as inputs to train the risk prediction model that performs more accurately than models trained using only historic data. In this manner, the risk prediction model is better enabled to predict changes that will fail.

Once a reliable predictive model is built, an “iterative patching process” first identifies low risk and high risk servers using a machine learning (ML) model. Additionally, the risk prediction model may be updated or re-trained during the process of implementing the changes to the devices. The changes to the devices may be implemented in stages, where the low risk devices are scheduled for automated implementation of the changes. An iterative process is used to re-train the risk prediction model based on outcomes of the previous iterations. For low risk devices, a change (e.g., patching) schedule is generated to which “change automation” is applied, meaning that these changes can be implemented without a change control board. For high risk devices, the risk prediction model may indicate causality on why a change will fail on a particular device. This causal factor analysis may be used to apply mitigative actions to prevent service disruptions.

Retraining of models is done continuously as change automation adhering to different maintenance windows changes devices in stages. The system learns from the past failures and readjusts the change schedules automatically for change automation of low risk devices. As new risk prediction models are built, the high or low risk of devices are determined for the devices remaining to be changed in the next stage, and automatic adjustments are made to the change plans.

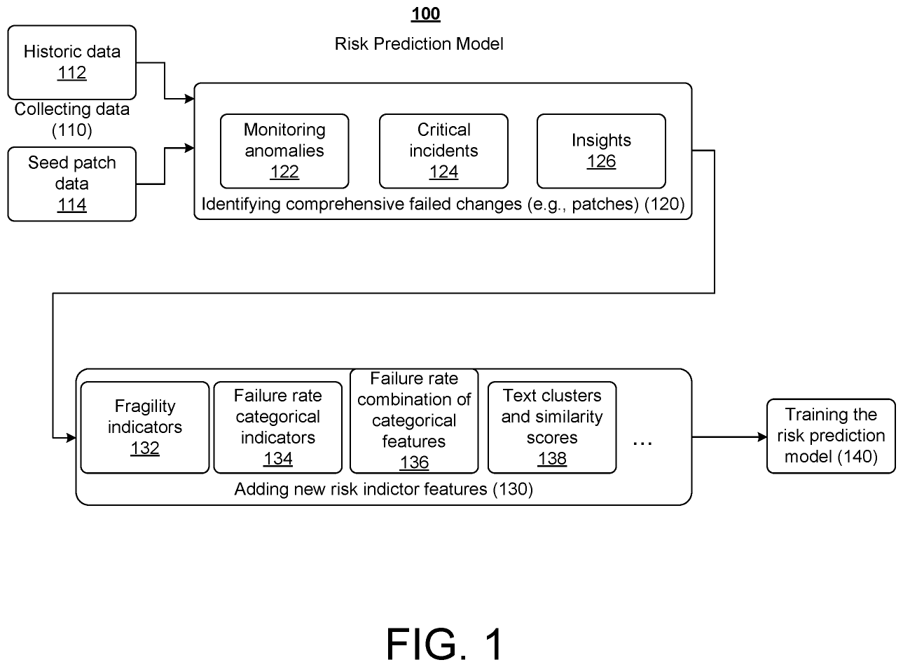

FIG. 1 is a block diagram of an example process 100 for generating a risk prediction model. The process 100 includes collecting data (110), identifying comprehensive failed changes (e.g., patches) (120), adding new risk indicator features (130), and training the risk prediction model (140). Each portion of the process 100 is described in more detail below.

Process 100 starts to build a risk prediction model using all the historic data available on failed changes. That is, process 100 includes collecting data (110) on past changes. That is, historic data 112 is collected. Historic data 112 includes data related to changes made on devices in a computing infrastructure. The historic data 112 includes device-characteristic data and the outcome of implementing the changes on the device.

Process 100 also includes collecting seed patch data 114. Seed patch data 114 includes data related to changes on a subset of devices (or test devices) from the computing infrastructure. In some examples, the number of test devices is usually a small number, t=1-20 devices (e.g., servers). After implementing an initial set of changes on a subset of devices, the changes are implemented on a slightly larger subset of the devices. For instance, the changes may be implemented on a set of 50-100 devices. In this manner, device-characteristic data is collected along with the outcome of implementing the changes on these devices.

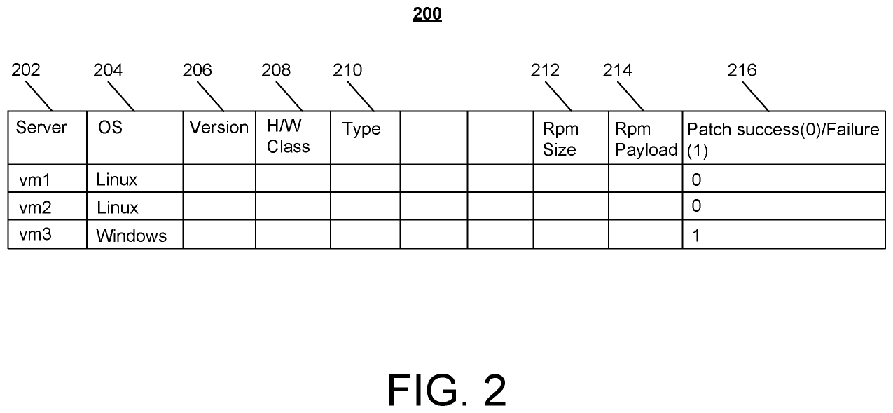

FIG. 2 illustrates an example format of the seed patch data 200 being collected during this step of the process 100. Initial seed patch data 200 may include fields for the device name 202, the OS (operating system) 204 (e.g., Windows and/or Linux, etc.), the version 206 of the OS, the H/W (hardware) class 208, and the type 210 of OS. Other fields related to the device characteristic that are not illustrated may include: the server purpose (e.g., web server, database server, etc.), the environment (e.g., development or production), the service or application running on the device, hardware drivers, OS drivers, central processing unit (CPU) size, memory size, disk size (e.g., available and remaining), applications installed, applications running, current patch state, position in the network (e.g., internal facing, external facing, etc.), and current security vulnerabilities (CSVs). Other fields related to the seed patch data 200 that are not illustrated may include a vendor, a time to deploy, a type of OS (e.g., Windows and/or Linux, etc.), and whether or not a reboot occurred or was needed. It is understood that this list of potential input fields are examples of the fields that may be included for device characteristics.

The seed patch data 200 also includes data collected relating to the patch details, as implemented on each device. The fields related to patch data may include package manager (Rpm) Size 212, which refers to the number of patches, Rpm Payload 212, which refers to the size of the payload in terms of bytes (e.g., bytes, megabytes, gigabytes, etc.), and a patch success (0)/failure (1) 216 field. The package manager, or Rpm, refers to a system that bundles a collection of patches and manages the collection of patches. The patch success (0)/failure (1) 216 field indicates whether or not the implemented patch succeeded or failed on the particular device by using a “0” for a successful implementation and a “1” for a failed implementation.

As discussed above, one challenge in training the risk prediction model using just historic data 112 and seed patch data 114 is the imbalance in the data, where the number of failed patches may be quite low (e.g., less than 1%). In these situations where the risk prediction model is trained only on this data, the risk prediction model may not be accurate in predicting the success or failure of implemented changes on a device.

Referring back to FIG. 1, process 100 improves the accuracy of the predictions of the risk prediction model by identifying comprehensive failed changes (e.g., patches) (120). Identifying comprehensive failed changes (120) may include one or more of monitoring anomalies 122, critical incidents 124, and insights 126. In this manner, the historic data 112 and the seed patch data 114 are augmented by collecting monitoring anomalies 122, critical incidents 124, and insights 126 as part of training the risk prediction model. Correlation techniques are used to identify if there is a causal relationship between the patch and monitoring spikes or critical incidents.

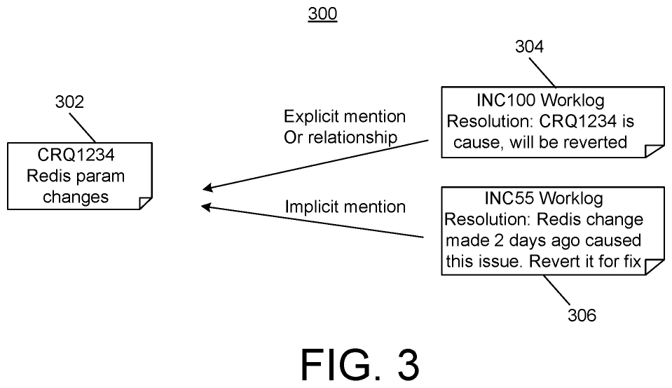

FIG. 3 illustrates an example graphic 300 for monitoring anomalies 122 and critical incidents 124 after implementing a change to a device. Monitoring anomalies 122, critical incidents 124, and insights 126 may include mining service incident tickets based on a service and a time aspect in order to determine if causal relationships exist.

For example, even if a patch is reported successful, if there is a significant spike or deviation in metrics ‘before’ and ‘after’ the patch, there is strong possibility that the patch caused this deviation. If a statistically significant deviation happens in metrics, then those servers may be marked as ‘latent’ failures even though a patch process marked them as successful. If a critical monitoring event is generated within X hours after patching, then those servers may be marked as ‘latent’ failures. Finally, if a root cause for an event is determined to be one of the servers that was patched, then the server is marked as a ‘latent’ failure.

In FIG. 3, a patch 302 is implemented. In this example, a CRQ is a change request. Patch 302 is labelled “CRQ1234 Redis param changes” meaning that change request “1234” was made to devices in the computing infrastructure. Service tickets 304 and 306 are mined as part of monitoring for anomalies. Service ticket 304 makes an explicit mention that the CRQ1234 is the cause of the incident. Service ticket 306 makes an implicit mention that a Redis change made two days ago is the cause of the incident. This demonstrates that both explicit and implicit mentions of the implemented change may be used. The text of the incident reports are mined for the explicit and implicit mentions, which is correlated to change data.

Service tickets may be mined for a period of days (e.g., 1 to 5 days) to identify any critical incident that occurs on a device or service, and critical metric anomalies, situations, and service degradations may be monitored for a period of hours (e.g., 1 to 12 hours, etc.). Of course, it is understood that other time periods may be used for the monitoring periods following implementing changes to a device.

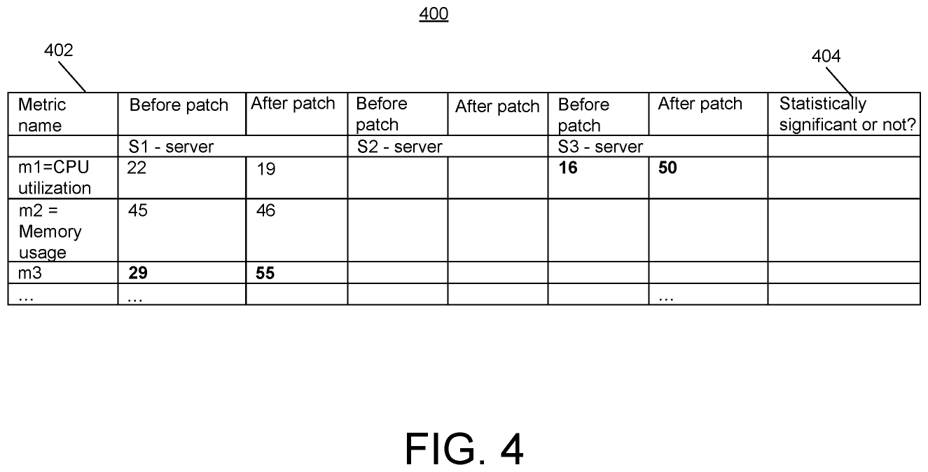

FIG. 4 illustrates an example table 400 that illustrates a comparison of metric values before and after a patch is applied. Table 400 includes multiple different fields such as a metric name 402 and fields for recording metrics before patch and after patch for different devices including three servers: S1, S2, and S3. The metric values before and after the patch are compared to determine whether they are statistically significant or not 404.

The comparison may be done by one of several different methods. For example, the comparison may be done by a simple ratio of the after metric to the before metric. If the ratio exceeds a configurable threshold, then the change is statistically significant. In some examples, the comparison may be done by a difference between the after metric and the before metric. If the difference exceeds a configurable threshold, then the change is statistically significant. In some examples, advanced statistical tests such as the Mann-Whitney U test or two sample t-tests may be used to determine if the change in metrics is statistically significant or not.

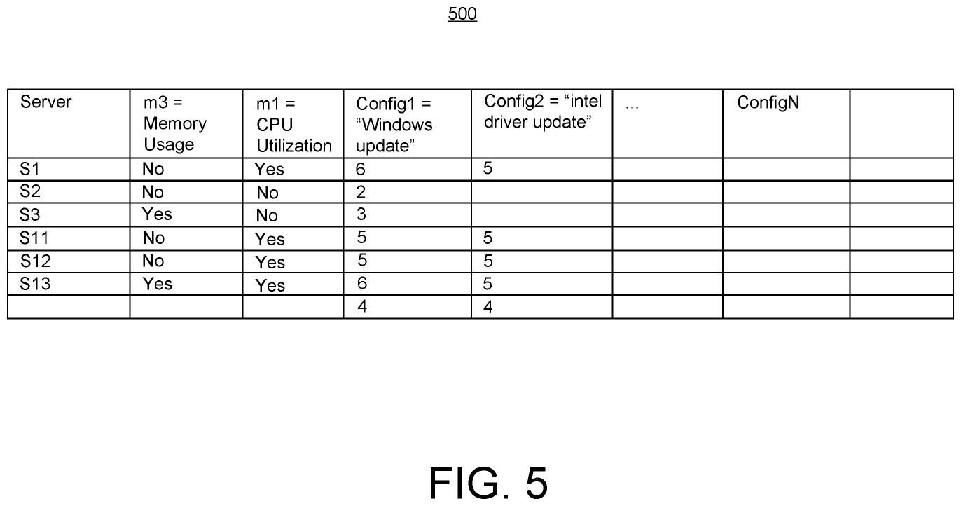

In the above example of FIG. 4, metrics={m1 for S3 and m3 for S1} are flagged since those two metrics shows a large deviation. This data is then correlated with configuration data to identify key insights on patterns being found in servers that may be leading to a change in metrics. In some examples, a standard Pearson Chi-X2 test and decision trees are used to discover these associations to identify which of the configuration variables from 1 through N (config1 . . . configN) are associated with the increase in specific metrics, m1 and m3. The patterns can then be extracted as shown below in the table 500 of FIG. 5.

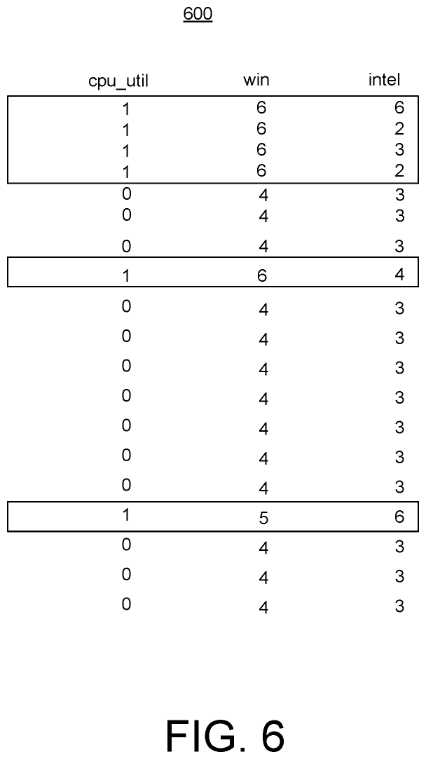

FIG. 5 illustrates the correlation between configuration variables (e.g., Windows update version, Intel driver update, etc.) and the monitoring metrics that have significantly changed before and after the patch change was applied. A “Yes” indicates that the metric value changed significantly, while “No” indicates that the metric value did not change significantly. This same information is illustrated in table 600 of FIG. 6, where the variables are transformed into numerical values so that machine learning algorithms can be run on the numerical values.

High m1 metric was found on S1, S11, S12 and S13 servers with “windows update >4.5”. This indicates that all servers with windows update at 4.5 or more are having high value of “CPU utilization”. For example, the servers S1 and S13 were configured with Windows update 6, which is greater than windows update 4.5. Similarly, the servers S11 and s12 were configured with Windows update 5, which is also greater than window update 4.5. The servers configured with windows update 5 and 6 exhibited a high m1 metric. In contrast, servers S2 and S3, which were configured with Window update 2 and 3, respectively, did not exhibit a high m1 metric. As illustrated in table 600 of FIG. 6, a sample run shows how the “win” variable is a deciding factor to classify whether metric m1 is impacted and has an association to the implemented changes.

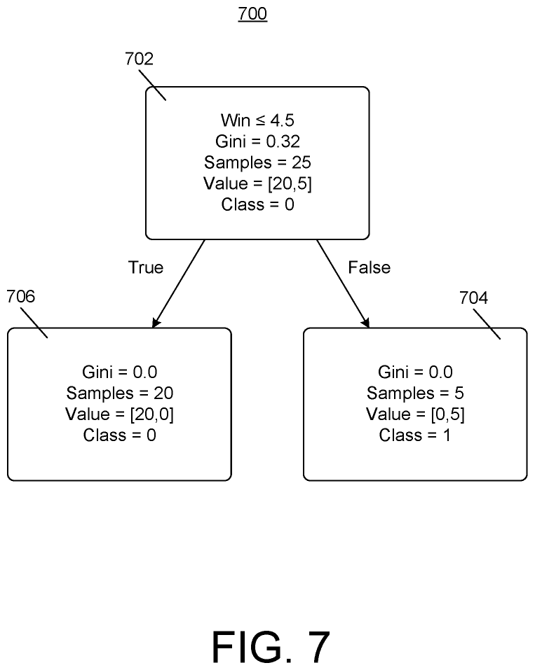

FIG. 7 illustrates an example decision tree 700. The generated decision tree 700 does not include the other configuration variables since the CPU utilization was explainable by just “win” windows update version only. The system filters out only key variables that are common and that can explain high m1 variation. Using the table 500 of FIG. 5 and the table 600 of FIG. 6, which illustrates the transformed numerical values, a predictive model can be built to explain the target monitoring variable “m1-CPU Utilization” and the other configuration variables. The decision tree 700 or model represented in FIG. 7 may be a classification or regression decision tree predictive model.

For example, the top box 702 represents that the model automatically determined a rule that when “win” parameter value >4.5, the value of m1 CPU utilization will be high (class=1) and it needs to take the right branch 704. When the value of “win” config parameter is <=4.5, it takes the left branch 706 and there is no impact on CPU utilization. While a decision tree algorithm is illustrated, any regression or classification algorithm can be used to build a correlation model between configuration (input) variables and metrics (target) variables. The critical incidents 124 of FIG. 1 that are created on the same service or server within a configurable time period after patching (service, time and text correlation) will also be marked to indicate ‘latent’ failure. In some examples, the configurable time period is represented by the variable “K”, where a typical value for K is 3 to 5 days.

In some examples, a similarity analysis may be performed between incidents and changes to determine causality. There may be multiple different ways to perform the similarity analysis. For example, one method for performing the similarity analysis includes using explicit mentions, such as the explicit mention or relationship from service ticket 304 of FIG. 3. Another method for performing the similarity analysis includes using implicit mentions, such as the implicit mentions from service ticket 306 of FIG. 3. Each of the method is described in more detail below.

As mentioned above, one method for performing the similarity analysis includes using an explicit mention or relationship using the text of a service ticket. For an explicit mention or relationship, a process is performed using a query to search for explicit text related to a particular patch. The process may include executable code to find the explicit text and determine whether or not there is a causal relationship. One example includes: 1) Performing a query of all service tickets to find all incidents with a “Description” or “Work log/notes” or “Resolution” of an incident to determine if there is a change identifier (e.g., usually PDCRQ . . . ) mentioned inside the TEXT. 2) If a change identifier is explicitly mentioned in the text, then check if the change was closed before the start of the incident to ensure that there is a causality from change to incident. 3) Then, check if the change closed or resolution date and the incident create date are within a period of time, for example, less than 2 weeks to ensure causality can be determined.

Also, as mentioned above, another method for performing the similarity analysis includes using an implicit mention from the text of a service ticket. For an implicit mention, a process is used to mine the text from service tickets and then to use entity- or keyword-matching. For example, entity- or keyword-matching may be performed using a large language model for coreference. The process may include executable code to determine if there is a causal relationship. One example includes: 1) for example, if a change CRQ1234 on a configuration item (CI) was “Changed REDIS parameters” and the incident text in the worklog stated “parameter changes done a week ago caused this issue,” then the overlap of the word, “parameter” increases the weight of this linkage. 2) Also change and timeline matching increases the confidence that the linkage exists. 3) If the worklog merely has, for example, the phrase, “changes were done that caused this issue,” then this will match “changes” that implicitly refers to CRQ1234. The sequential order of (CRQ) and (INC) are also checked. 4) For a root cause conclusion, CRQ must have happened before INC otherwise, the CRQ refers to a fix and not a root cause.

Once the service, time and text correlated monitoring and incident events are filtered out for each change, a score is computed for each change to determine whether the change was a latent failure or success. The change was marked in the system as successful by the method described below will determine whether to “flip” it, i.e., mark it as “failed”. The generation of this label for each change of either “success” or “fail” can be done by a weighted majority voting, averaging methods, or a weak supervision neural machine learning (ML) model that predicts the label for the change based on noisy labels from one or more monitoring anomalies 122 or critical incidents 124 of FIG. 1. Although monitoring anomalies 122 and critical incidents 124 are considered as primary sources in this example, the approach is not limited to just these two. If there are other types of events collected, for example, this method can be extended to things such as outage analysis, situation detection, business monitoring, etc.

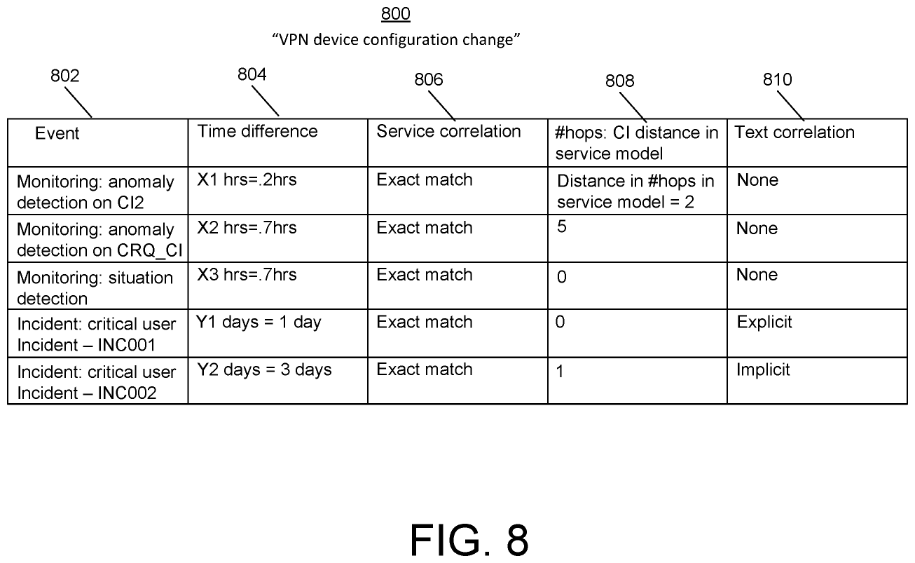

For each change request, CRQ, monitoring anomalies 122 and critical incidents 124 that match, service, time and text criteria are collected. Referring to FIG. 8, an example table 800 illustrates a “VPN device configuration change.” Table 800 includes an event 802, a time difference 804, a service correlation 806, a #hops: CI distance in service model 808, and a text correlation 810. As an example, a “VPN device configuration change” that is implemented on devices in a computing infrastructure may include the following parameters, which are not listed in FIG. 8: CRQ has {CRQ_start_time, CRQ_end_time, CRQ_service=VPN and CRQ_Cis=CRQ_1, CRQ_2 where the configuration change was made. The configuration change has associated three monitoring and two incident events 802 that are filtered and correlate with time difference 804 and service correlation 806 constraints. In this example, the time interval for monitoring is represented by the variable Xconf and the variable is set to <Xconf hrs=1, which is user configurable, and the time interval for incident is represented by the variable Yconf and the variable is set to <Yconf days=5 days, which is user configurable. Scores are calculated for each event based on when the event occurred relative to the particular time variable appropriate for that event (e.g., either Xconf or Yconf).

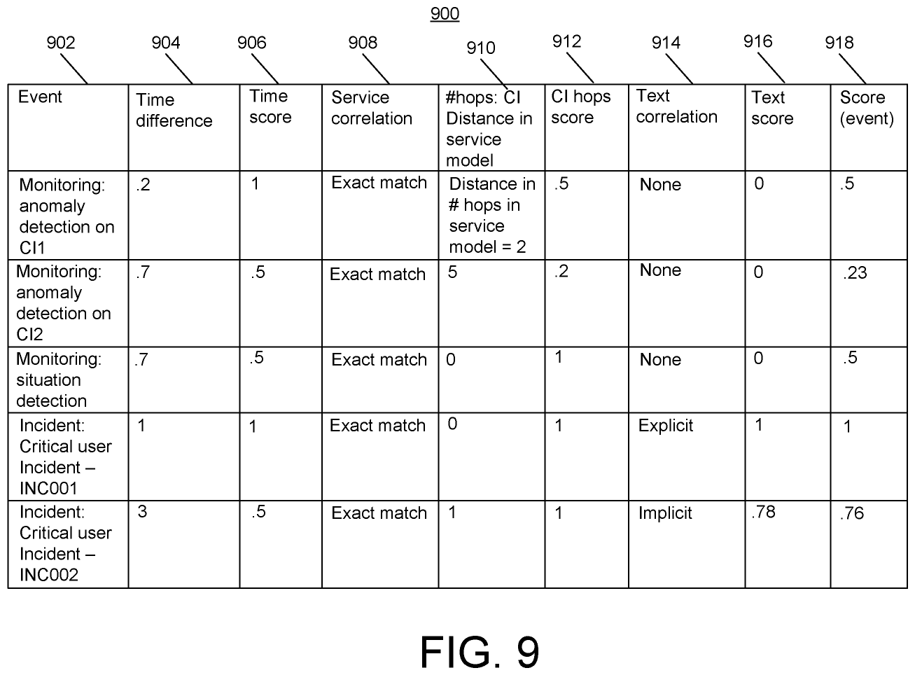

FIG. 9 illustrates an example table 900 that show a score for each event generated. FIG. 9 includes an event 902, a time difference 904, a time score 906, a service correlation 908, a #hops: CI distance in the service model 910, a CI hops score 912, a text correlation 914, a text score 916, and a score (event) 918. It is generated by using configuration settings of Xconf=1 hr and Yconf=5 days.

To calculate the time score 906: Time score=1 if time difference <=Xconf/2, 0.5 if Xconf/2<time difference <=Xconf, 0 if time_difference>Xconf. For monitoring, such as in the monitoring:anomaly detection on CI1 (first row in FIG. 9), the time difference is computed as 0.2 hrs meaning that this event happened within 0.2 hrs after the change was implemented. Using the time score formulae, we compute Time score=1 as 0.2<(1/2)=. 5. For the second event, the time difference is Xconf-. 7 hrs which is between 0.5 hrs and 1 hr. We use a score of 0.5.

For incidents, such as in the “Incident:critical user incident INC001”, Y1=1 day and Yconf=5 days. Hence, applying a similar formulae,
Time score=
1 if time difference <=Yconf/2,
0.5 if Yconf/2<time difference <=Yconf,
0 if time_difference>Yconf,
   Yconf=5/2=2.5 days, and hence the time score for this incident is 1 as the time difference is <2.5 days.
   For the 2nd incident, Y2=3 days which is >2.5 but less than 5 and hence time score is 0.5.

To calculate the CI hops score 912: CI hops score=1 if #hops=0, else 1/# hops (e.g., 2 hops will be 0.5, 3 hops will be 0.33 etc.).

To calculate the text score 916: Text score=1 if explicit mention, <probability between 0 . . . 1> if implicit mention through a large language model.

To calculate the Score(event) 918: Score(event)=wt1*time score+wt2*CI hops score+wt3*text score where wt1, wt2 and wt3 are also configurable just as are: Xconf=1 hr, Yconf=2.5 days. In this example, wt1=wt2=wt3=0.3.

In some examples, the score (event) 918 at the overall change level can be done by various different methods including, for instance, averaging, majority voting, and using a neural model.

For example, using averaging to calculate the score for the overall change using the score (event) 918 will yield (0.5+0.23+0.5+1+0.76)/5=59. Since 0.59 is greater than 0.5, which is a configurable threshold for averaging, then the change is marked as failed.

For example, using majority voting to calculate the score for the overall change using the score(event) 918 will yield four scores greater than or equal to 0.5, while one score is less than or equal to 0.5. Therefore, the majority is yes, and the change is marked as failed.

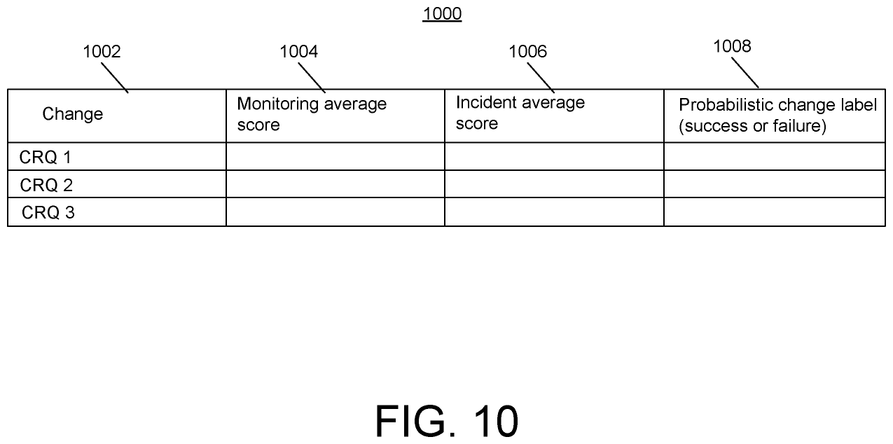

Finally, a neural model can also be constructed with this data from table 900 by using a generative ML model to predict a probabilistic label of each change. FIG. 10 illustrates an example table 1000 related to the generative ML model. The table 1000 includes fields for the change 1002, the monitoring average score 1004, the incident average score 1006, and the probabilistic change label (success or failure) 1008, where the output from the ML model is either success or failure. In some implementations, the generative ML model may use weak supervision to derive the probabilistic change label 1008 as success or failure.

Once the labels are generated using any one or more of the above methods, the information generated by these methods augments the dataset with more latent failures than presently marked in the system using just the historic data 112 and/or the seed patch data 114.

Referring back to FIG. 1, process 100 includes adding new risk indicator features (130). The risk indicator features may include fragility indicators 132, failure rate categorical indicators 134, failure rate combination of categorical features 136, and text clusters and similarity scores 138. These risk indicator features are derived from the data automatically using clustering and/or grouping methods. In this manner, knowledge is extracted from the historic patterns and used as learning signals for machine learning to train the risk prediction model (140).

Based on identifying comprehensive failed changes (e.g., patches) 120 of process 100, one or more patch watchlist metrics are identified. The patch watchlist metrics are a subset of metrics that show significant difference (anomalies) as metrics that are monitoring anomalies 122 during the patching process. These patch watchlist metrics are also treated as one of the features to patch failure prediction in the risk prediction model.

The first part to add new risk indicator features is to determine the failure rates for each categorical variable that forms key risk indicators extraction from data. For example, an OS categorical variable may have two values: Windows and Linux. Thus, a failure rate for “Windows” and a failure rate for “Linux” are computed. For example, a version categorical variable may have five values, such that failure rates for each are calculated, for example: “Windows 11 failure rate”, “Windows 12 failure rate”, “Ubuntu-12 failure rate”, ““Ubuntu-13 failure rate”, “Red Hat 14 failure rate”. The memory has three values: High, Medium and Low, and failure rates are graded accordingly. For example, a support group categorical variable may include a list of all support groups such that a failure rate for each support group, for example, “Windows-SG failure rate,” may be calculated.

In some examples, failure rates for specific combinations of categorical variables are calculated. For instance, the following failure rates may be calculated: a. “Windows 11-low memory failure rate”; b. “Windows 11-high memory failure rate”; c. “Windows 11-Windows-SG”; and d. “Window 11-Arch-SG”. The set of configure variables to measure may be a controlled parameter based on domain knowledge. These variables may become additional features into the training data.

Patch description can also be converted to a categorical variable by running a clustering algorithm on text and using the cluster caption and degree of similarity as well as additional metrics associated with this cluster. Using cluster metrics allows categorization of each patch to similar patches. As examples, the following may be converted to a categorical variable: a. Cluster caption/title category; b. Cluster cosine similarity, and c. Testing quality metrics with their z-scores (e.g., how far statistically the metrics deviate from class-based average or from standard deviation).

Another key risk indicator can be fragility indicators 132 of a service or configuration item (CI). These may be identified over the historic data 112 range to indicate whether a service or CI is highly “fragile” (i.e., it breaks often or is quite stable).

Criteria may include:
a. # of times a CI or service is down in the last 7 days
b. # of times a CI or service is downgraded in the last 7 days
c. Above 2 metrics but for other periods of time (e.g., 30 days and 90 days).

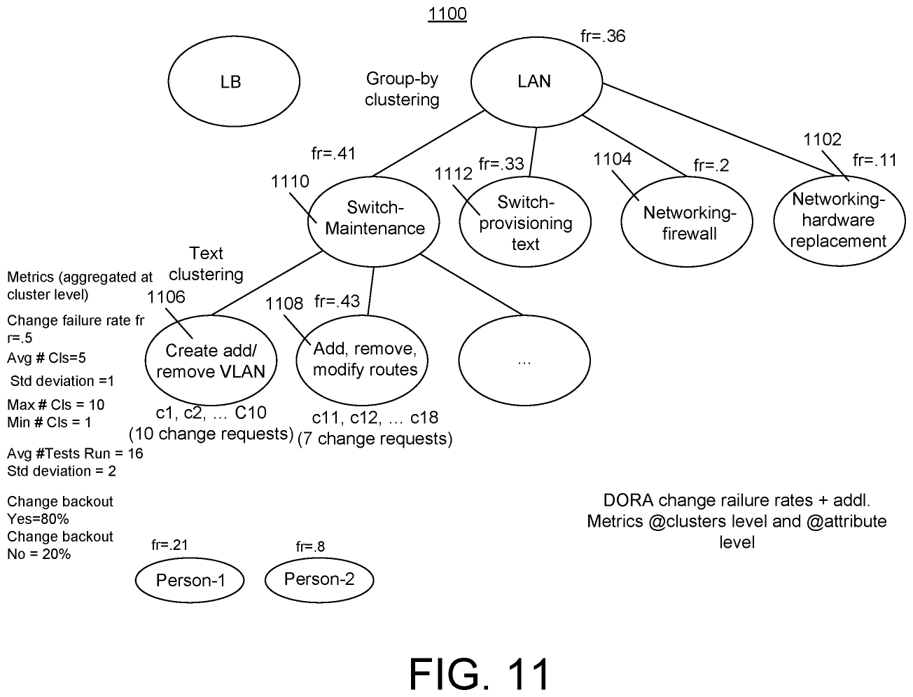

In general, fragile services typically suffer higher patching failures. FIG. 11 is an example clustering 1100 of change records where clustering on text is applied after a grouping by categorical variables. In this example, networking-hardware replacement 1102 has a low failure rate of 0.11 meaning that it is at low risk of failure. The networking-firewall 1104 has a medium failure rate of 0.2 meaning that it is at a moderate risk of failure. The remaining clusters: create add/remove VLAN 1106, add, remove, modify routes 1108, switch-maintenance 1110, and switch-provisioning text 1112 all have higher failure rates and are at high risk for failure.

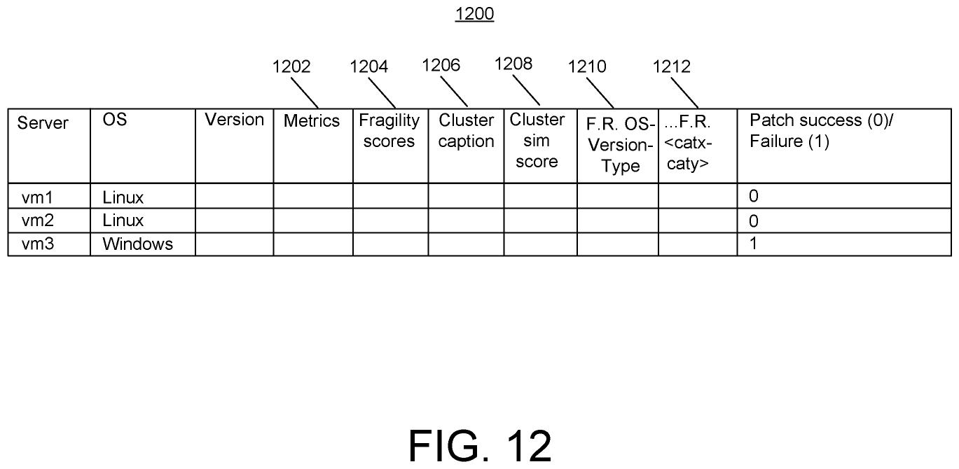

FIG. 12 illustrates an example table 1200 with the enriched training data. The enriched training data includes multiple features from cluster-specific features and failure-rate features (F.R.), as well as metrics and fragility-related features. These additional features include metrics 1202, fragility scores 1204, cluster caption 1206, cluster sim score 1208, F.R. OS-version-type 1210, and F.R. <catx-caty> 1212. These additional risk indicator features enhance building a robust ML model.

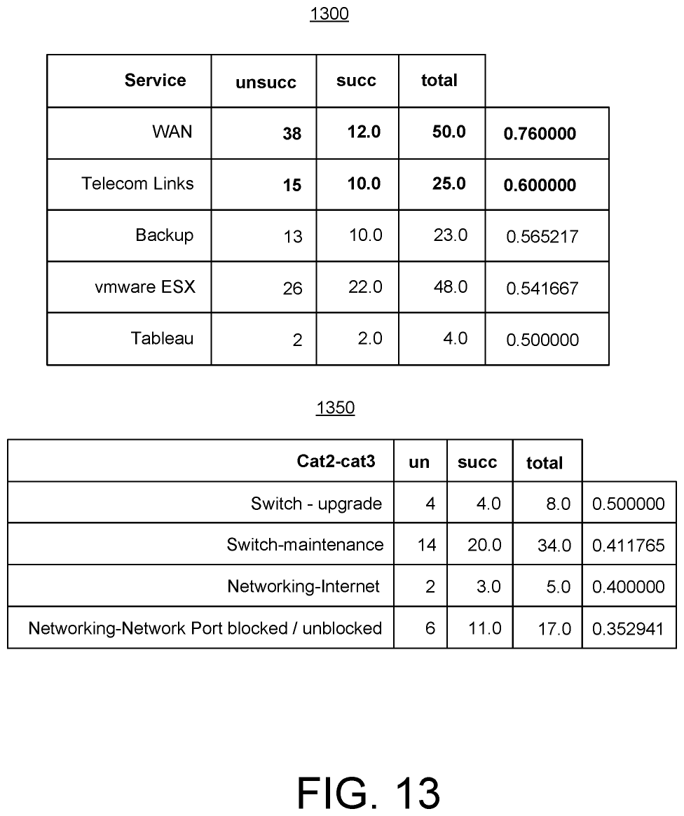

Additionally, risk indicator features also provide insights. FIG. 13 illustrates example tables 1300 and 1350 with these insights. FIG. 13 provides examples of how aggregated failure rate across services (1300) or category combinations (1350) can provide insights. For example, “WAN” service has a high failure rate of 76% computed over 50 WAN changes. Any change that is related to switch upgrades (“Switch-Upgrades”) also shows a 50% probability of failure computed over eight changes historically.

Referring back to FIG. 1, risk prediction model 100 includes training the risk prediction model 140. Determined data are used as inputs to train the model. In this example, both supervised learning and unsupervised learning are used to train the risk prediction model. The risk prediction model functions as a classifier to output a probability of an implemented change succeeding or failing on a device. The risk prediction model may be based on using a model such as, for example, extreme gradient boosting (XGBoost), which is a scalable, distributed gradient-boosted decision tree, or support vector machine (SVM). By including additional data to train the risk prediction model, an approximate 10 to 20% point improvement has been realized in the output of the risk prediction model.

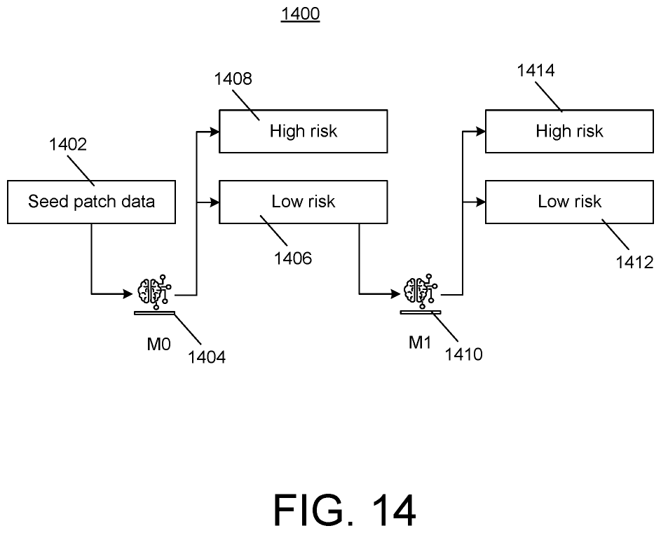

FIG. 14 illustrates an example process 1400 for iteratively training the risk prediction model, classifying the devices as low risk or high risk, re-training the risk prediction model, and classifying the remaining devices as low risk or high risk. The seed patch data 1402 is input to the risk prediction model “M0” 1404. The risk prediction model M0 1404 is run on all unpatched servers to classify into the unpatched servers as low risk 1406 or high risk 1408 servers.

The root cause also may be provided for high risk 1408 servers. For high risk 1408 servers, causality is identified by identifying specific ‘features’ that are the primary attribution to the failure. As discussed above, this can be achieved through XGBoost, as a tree-based ML model. For example, certain combination of configurations, or installed patches can lead to failures. All failures are grouped, and this insight is presented as root cause contribution to the failures.

After classifying the servers, a patching schedule is generated for patching the low risk 1406 servers patched initially. For example, a portion of the low risk 1406 servers may be scheduled for patching in the first iteration. In this example, the generated schedule may be, for example, a weekly schedule, but it is understood that the generated schedule may be some other periodicity such as hourly, daily, bi-weekly, etc.
Week-1—# of servers: n1
Week-2—# of servers: n2
. . .
Week-p—# of servers: np

The schedule may be generated, for example, based on maintenance windows, redundancy relationships and business considerations (e.g., Priority, service level agreements (SLAs), etc.).

Referring to FIG. 14, the patches are implemented on the week-1 n1 servers, and the data about patch success or failure may be used to rebuild a new risk prediction model “M1” 1410 model by following the above steps iteratively. Note that this risk prediction model M1 1401 learns about all failures across servers to start identifying which combinations of configurations can lead to failures.

The new model M1 is now used to predict patch failures on remaining unpatched servers and classify them as low risk 1412 servers or high risk 1414 servers. The patch schedule for the remaining low risk 1412 servers is revised based on the classification output from the risk prediction model M1 1410. For example, week 2 had original plan of patching n2 servers, but after the risk prediction model M1 1410 is used, a few of the servers might be deemed high risk 1414 servers and move out of the week 2 schedule. The new week 2 # of servers will now be ‘n2’ which may be primarily low risk 1412 servers.

The process 1400 is repeated by applying patch to ‘n2’ servers on week 2 and follow the similar process to generate a new risk prediction model “M2” to update the schedule.

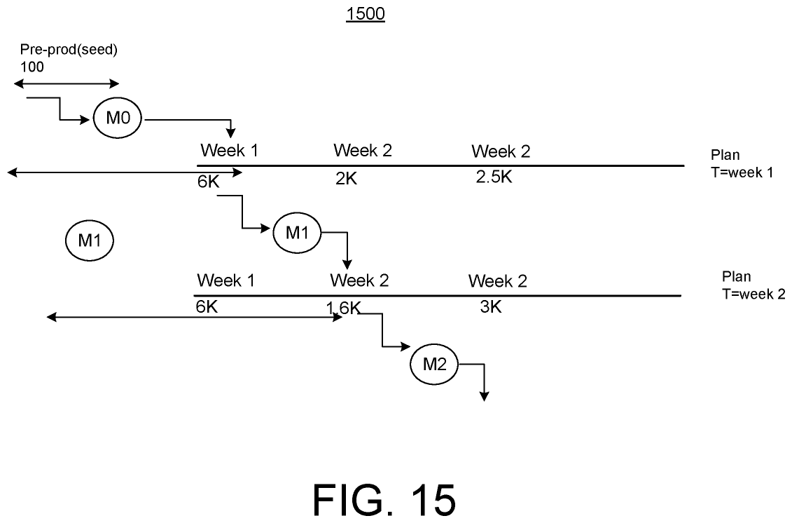

Referring to FIG. 15, an example process 1500 illustrates a continuous patching plan. In this example, 11,000 servers in a large computing infrastructure need to have changes implemented (or software patches installed). For example, seed patching may be run on 120 servers (Test+Seed) to build the initial risk prediction model: M0. The risk prediction model M0 is used to predict which of the remaining servers are high risk and generate a list of high risk servers and low risk servers. For low risk servers, an automated weekly plan may be built (e.g., week1-6K, week2-2K, week3-2.5K) based on maintenance windows. In contrast, high risk servers may have root cause analysis that may be mitigated by administrators of the high risk servers independently running additional tests. For low risk servers, the week1 patching cycle may be run on 6,000 servers, which may result with an additional set of failures. At the end of week, the combined data of 120 servers plus 6000 servers mean that 6120 servers are used to build the next version of the risk prediction model: M1. The risk prediction model M1 is applied to remaining servers to identify a new list of low risk servers. A new weekly plan may be built (week2-1.6K, week2-3K) that is different from the original plan. This iterative staged patching continues until all servers are patched.

This shows how the plan adapts continuously as models become better in capturing failure and using the failures in each week to drive the rebuilding of ML model and changed schedule.

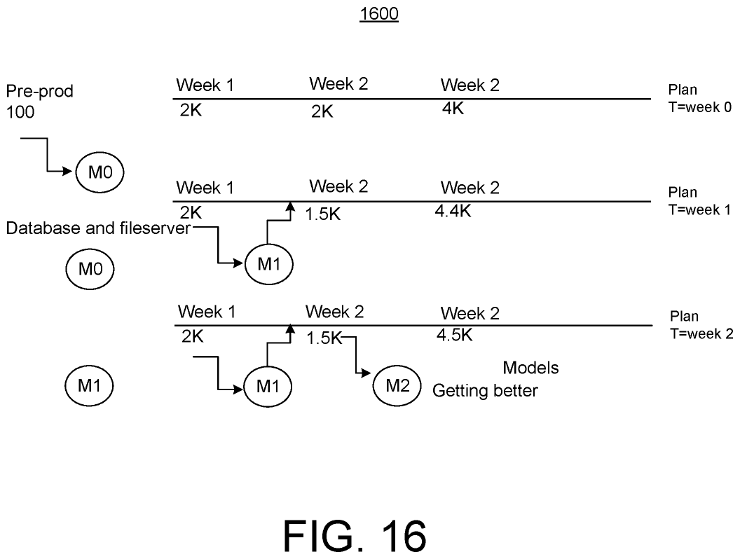

Referring to FIG. 16, an example process 1600 illustrates another continuous patching plan. In this example, 8000 servers need to be upgraded. At first, 100 servers are seed patched. The initial risk production model M0 is built and run on the unpatched servers to classify the unpatched server as low risk servers or high risk servers. A weekly patching schedule is autogenerated for the low risk servers based on post patch data and server criticality. The schedule suggested by the risk prediction model M0 may be week1-2K, week2-2K, week3-4K. In each phase, the risk prediction model identifies metrics that shows deviations or anomalies. These metrics can be categorized as IO-intensive servers are impacted, for example, servers that are hosting database or file transfer protocol (FTP) servers. Once categories are identified, patch release notes may be reviewed and related documents to find a required patch to set some minor IO configuration may be documented. The risk prediction models can identify and highlight impacted areas that helps users mitigate risk in time.

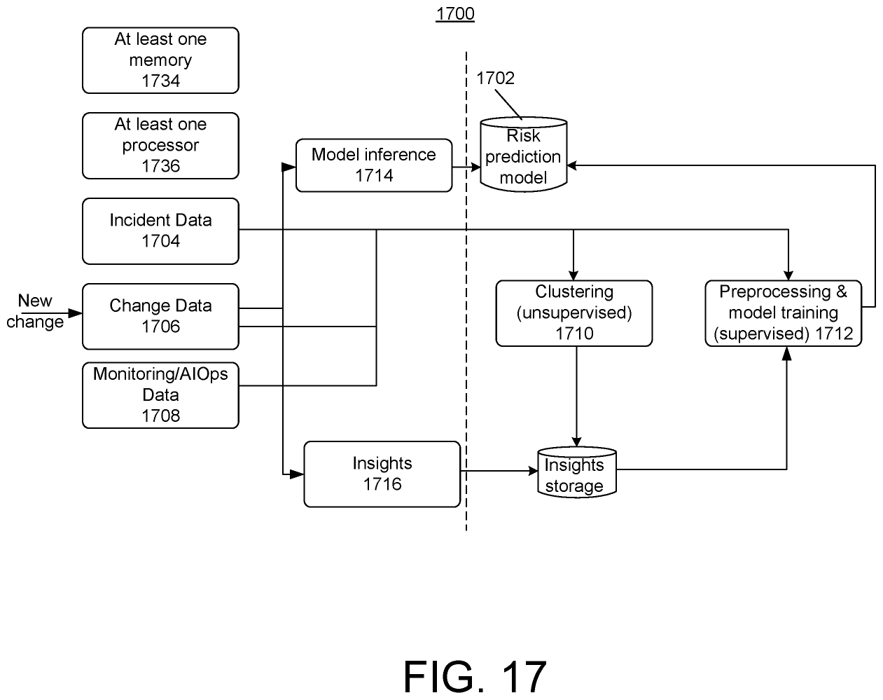

Referring to FIG. 17, an example block diagram of a system 1700 for implementing changes on devices is illustrated. The risk prediction model 1702 is generated from information related to incident data 1704, change data 1706, and monitoring/AIOps data 1708. This data is used to train the risk prediction model 1702 using both clustering (unsupervised) 1710, which is unsupervised learning, and pre-processing and model training (supervised) 1712, which is supervised learning. The output of the pre-processing and model training is the risk prediction model 1702.

When a new change is being implemented, the model inference 1714 may be queried to get a probability of failure/risk from the risk prediction model 1702. Also, the insights 1716 may be queried to determine the closest matching cluster and to identify the descriptive statistics for that cluster, which may show “noncompliance” or deviations related to the new change. Failure rate aggregate statistics may also be retrieved.

The system 1700 may be implemented on a computing device (or multiple computing devices) that includes at least one memory 1734 and at least one processor 1736. The at least one processor 1736 may represent two or more processors executing in parallel and utilizing corresponding instructions stored using the at least one memory 1734. The at least one processor 1736 may include at least one CPU. The at least one memory 1734 represents a non-transitory computer-readable storage medium. Of course, similarly, the at least one memory 1734 may represent one or more different types of memory utilized by the system 1700. In addition to storing instructions, which allow the at least one processor 1736 to implement the system 1700, the at least one memory 1734 may be used to store data and other information used by and/or generated by the system 1700.

Implementations of the various techniques described herein may be implemented in digital electronic circuitry or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may, or be operatively coupled to, receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware or front-end components. Implementations may be implemented in a mainframe computing system. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A method for implementing a change to a plurality of devices in a computing infrastructure, the method comprising:
generating a risk prediction model, the risk prediction model trained using a combination of supervised learning and unsupervised learning;
identifying, using the risk prediction model, a first set of devices from the plurality of devices having a low risk of failure due to implementing the change and a second set of devices from the plurality of devices having a high risk of failure due to implementing the change;
generating a schedule for automatically implementing the change to the first set of devices;
implementing the change to a portion of the first set of devices according to the schedule;
updating the risk prediction model using data obtained from implementing the change to the portion of the first set of devices; and
iteratively performing the identifying, the generating, the implementing, and the updating.

2. The method as in claim 1, wherein the change to the plurality of devices includes a software patch to a plurality of computing devices.

3. The method as in claim 1, wherein generating the risk prediction model comprises:
collecting historic data on previous changes implemented on the plurality of devices;
implementing the change to a test group of the plurality of devices;
identifying failed devices from the test group where implementing the change failed to be implemented; and
inputting data from the failed devices to the risk prediction model.

4. The method as in claim 3, wherein generating the risk prediction model further comprises:
monitoring metrics for the test group of the plurality of devices where implementing the change failed;
correlating deviations in the metrics with configuration data for the test group of the plurality of devices where implementing the change failed; and
determining a causal relationship between the change and the metrics.

5. The method as in claim 1, wherein the unsupervised learning includes clustering data to include risk indicator features for generating the risk prediction model.

6. The method as in claim 3, wherein the supervised learning includes historic data and data from implementing the change to the test group.

7. A computer program product for implementing a change to a plurality of devices in a computing infrastructure, the computer program product being tangibly embodied on a non-transitory computer-readable medium and including executable code that, when executed, is configured to cause at least one computing device to:
generate a risk prediction model, the risk prediction model trained using a combination of supervised learning and unsupervised learning;
identify, using the risk prediction model, a first set of devices from the plurality of devices having a low risk of failure due to implementing the change and a second set of devices from the plurality of devices having a high risk of failure due to implementing the change;
generate a schedule for automatically implementing the change to the first set of devices;
implement the change to a portion of the first set of devices according to the schedule;
update the risk prediction model using data obtained from implementing the change to the portion of the first set of devices; and
iteratively perform the identifying, the generating, the implementing, and the updating.

8. The computer program product of claim 7, wherein the change to the plurality of devices includes a software patch to a plurality of computing devices.

9. The computer program product of claim 7, wherein generating the risk prediction model comprises executable code that, when executed, is configured to cause the at least one computing device to:
collect historic data on previous changes implemented on the plurality of devices;
implement the change to a test group of the plurality of devices;
identify failed devices from the test group where implementing the change failed to be implemented; and
input data from the failed devices to the risk prediction model.

10. The computer program product of claim 9, wherein generating the risk prediction model further comprises executable code that, when executed, is configured to cause the at least one computing device to:
monitor metrics for the test group of the plurality of devices where implementing the change failed;
correlate deviations in the metrics with configuration data for the test group of the plurality of devices where implementing the change failed; and
determine a causal relationship between the change and the metrics.

11. The computer program product of claim 7, wherein the unsupervised learning includes clustering data to include risk indicator features for generating the risk prediction model.

12. The computer program product of claim 9, wherein the supervised learning includes historic data and data from implementing the change to the test group.

13. A system for implementing a change to a plurality of devices in a computing infrastructure comprising:
at least one processor; and
a memory storing instructions that, when executed by the at least one processor, causes the at least one processor to:
generate a risk prediction model, the risk prediction model trained using a combination of supervised learning and unsupervised learning;
identify, using the risk prediction model, a first set of devices from the plurality of devices having a low risk of failure due to implementing the change and a second set of devices from the plurality of devices having a high risk of failure due to implementing the change;
generate a schedule for automatically implementing the change to the first set of devices;
implement the change to a portion of the first set of devices according to the schedule;
update the risk prediction model using data obtained from implementing the change to the portion of the first set of devices; and
iteratively perform the identifying, the generating, the implementing, and the updating.

14. The system of claim 13, wherein the change to the plurality of devices includes a software patch to a plurality of computing devices.

15. The system of claim 13, wherein generating the risk prediction model comprises instructions that, when executed, is configured to cause the at least one processor to:
collect historic data on previous changes implemented on the plurality of devices;
implement the change to a test group of the plurality of devices;
identify failed devices from the test group where implementing the change failed to be implemented; and
input data from the failed devices to the risk prediction model.

16. The system of claim 15, wherein generating the risk prediction model further comprises instructions that, when executed, is configured to cause the at least one processor to:
monitor metrics for the test group of the plurality of devices where implementing the change failed;
correlate deviations in the metrics with configuration data for the test group of the plurality of devices where implementing the change failed; and
determine a causal relationship between the change and the metrics.

17. The system of claim 13, wherein the unsupervised learning includes clustering data to include risk indicator features for generating the risk prediction model.

18. The system of claim 15, wherein the supervised learning includes historic data and data from implementing the change to the test group.
